(19) United States
(12) Patent Application Publication
(10) Pub. No.: US 2012/0099102 A1
(43) Pub. Date: Apr. 26, 2012

(54) DUAL AND MULTI-WAVELENGTH SAMPLING PROBE FOR RAMAN SPECTROSCOPY

(76) Inventor: Job M. Bello, Swansea, MA (US)

(21) Appl. No.: 12/912,112

(22) Filed: Oct. 26, 2010

(51) Int. Cl. G01J 3/44

(52) U.S. Cl. 356/301

(57) ABSTRACT

In certain embodiments, the invention relates to optical probes and methods for conducting Raman spectroscopy of a material at multiple excitation wavelengths. The probes and methods utilize optical elements to focus outputs from a plurality of light sources or lasers onto a sample, collect backscattered light from the sample, separate Raman spectra from the backscattered light, and provide at least one output containing the spectra. By utilizing multiple excitation wavelengths, the probes and methods avoid Raman measurement issues that may occur due to, for example, fluorescence and/or luminescence.

### GOVERNMENT RIGHTS

This invention was made with Government support under Contract No. NNX10CF16P awarded by the U.S. National Aeronautics and Space Administration. The Government has certain rights to this invention.

### FIELD OF THE INVENTION

This invention relates generally to optical probes for conducting Raman spectroscopy. More particularly, in certain embodiments, the invention relates to optical probes for conducting Raman spectroscopy of a material at multiple excitation wavelengths.

### BACKGROUND OF THE INVENTION

Raman spectroscopy is a technique for characterizing materials according to the frequency of their molecular vibrations. The basic measurement entails irradiating a sample with a monochromatic light source, typically a laser, and analyzing the spectroscopic distribution of the scattered light. The Stokes-shifted Raman spectra are obtained as a series of lines at longer wavelengths with respect to the exciting source. A full range Raman spectrum covers a frequency span of zero cm⁻¹ to about 4000 cm⁻¹. Raman spectroscopy has many uses for identifying and characterizing materials.

In practice, Raman measurements may encounter several problems that may serve to mask or interfere with the Raman spectrum signal. It is well known, for example, that fluorescence arising from the sample may create a large background that may overwhelm the Raman scattering. Alternatively, sharp fluorescence or luminescence bands may arise from the sample which are confused with Raman lines. Such fluorescence interferences can often be mitigated by employing a different excitation laser wavelength, one that does not coincide with the absorption spectrum of the fluorescing species. However, Raman instruments typically have only a single excitation wavelength available at a time, and obtaining Raman spectra with different excitation lasers is cumbersome.

Frequently, the fluorescence background may be minimized by employing a longer wavelength excitation source, since the number of fluorescent impurities usually decreases with increasing wavelength. For this reason, many commercial Raman spectrometers are supplied with a single near-infrared laser source, e.g., a 785 nm diode laser. However, such longer wavelength excitation is not always the judicious choice. For example, when instruments use silicon-based detectors, such as conventional charge coupled detectors (CCDs), the response drops off sharply with wavelength, approaching zero at about 1050 nm. With the 785 nm laser, most of the Raman spectrum is in a region of rapidly declining detector sensitivity, and CCD sensitivity is essentially zero by about 3200 cm⁻¹. However, for mid-visible excitation sources, such as the commonly used 532 nm laser, the Raman spectrum spans a range of 532 nm to 676 nm (i.e., 532 nm-4000 cm⁻¹) for a full range Raman spectrum, a region where Si detectors have their maximum response. Thus, for obtaining a full range spectrum with maximum sensitivity, a 532 nm laser is preferred; for minimizing fluorescence, if it is a problem, 785 nm is often better. Therefore, a device and method for obtaining Raman spectra simultaneously with 532 nm and 785 nm excitation sources (or other short-long excitation wavelength combinations) would be desirable.

A particularly favorable configuration for Raman sampling is the fiber optic Raman probe as described in, for example, U.S. Pat. Nos. 5,112,127, 5,911,017, 4,573,761, and 5,978,534. Such fiber optically coupled sampling probes enable the sample to be at some distance from the spectrograph and are frequently compact and hand-held. In U.S. Pat. No. 5,112,127, for example, laser light is conducted down one optical fiber and focused onto the sample. The scattered light is then collected with suitable optics, focused into one or more optical fibers, and conducted back to the spectrograph and detector. These and similar fiber optic probes have internal filtering optics that are tuned to a single excitation wavelength.

For the above reasons, there is a need for increased efficiency, accuracy, and accessibility in Raman measurements. Improvement is needed, for example, to avoid interference from luminescence and/or fluorescence bands, to provide Raman spectra in regions where detectors have their maximum response, and to provide probes that are compact and/or handheld.

### SUMMARY OF THE INVENTION

It is an object of this invention to provide a fiber optic sampling probe that enables the Raman spectrum of a sample to be obtained at two or more excitation wavelengths simultaneously. The probe further provides the sampling region of the two or more wavelengths to be coincident so that spectra are obtained at identical spatial regions. The probe enhances measurement efficiency by providing two or more Raman spectra simultaneously, and it improves accuracy by avoiding interference from fluorescence and/or luminescence.

The probe has separate channels for each excitation wavelength and its corresponding Raman spectrum. Thus, the probe for n wavelengths may contain n laser inputs and n spectrum outputs. The laser inputs may include optical fibers coupled to the laser sources. The optics within the probe combine these excitation beams and focus the combined beams onto the sample. The backscattered light is collected by the same focusing lens. Internal optical elements separate the scattered light into the wavelength segments containing the Raman spectrum. Each spectrum is directed to a separate output channel, which, for use in a fiber optically coupled probe configuration, may be directed to separate output fiber optics or combined into a single output fiber. The one or more output fibers are directed to the input of one or more spectrographs where the spectra are presented separately or simultaneously.

A useful compact probe is a dual wavelength probe that includes two excitation lasers (i.e., n=2). The dual wavelength probe may be constructed with a shorter (e.g., visible) excitation laser source and a longer (e.g., near infrared) excitation laser source. Such a probe has the advantage of allowing Raman spectra of a sample to be obtained at the shorter wavelength where possible, but to revert to the longer wavelength if there is too much fluorescence or absorption-induced heating from the visible source. The shorter wavelength will usually be favored as it has the advantages of higher Raman scattering intensity, higher detector efficiency with silicon-based detectors, and broader spectral range coverage. For example, with a 532 nm or other shorter wavelength excitation, the Raman spectral coverage can be extended to a region greater than 4000 cm⁻¹, which cannot be achieved with a 785 nm excitation due to the silicon CCD detector sensitivity drop-off at greater than about 1050 nm, or beyond about 3200 cm⁻¹ in the Raman spectrum. Many materials, for example, have —OH vibrational band frequencies in the 3200-3700 cm⁻¹ region.

There are a number of advanced types of Raman spectroscopy for which certain embodiments of the invention may be used, including resonance Raman, surface-enhanced Raman, tip-enhanced Raman, polarised Raman, stimulated Raman (analogous to stimulated emission), transmission Raman, spatially-offset Raman, and hyper-Raman.

In one aspect, the invention relates to a sampling probe for conducting Raman spectroscopy at a plurality of excitation wavelengths. The probe includes, in a single housing, optical components for combining a plurality of discrete nominal wavelengths of excitation light from one or more sources into a single collimated beam, focusing the beam onto a sample, collecting backscattered light from the sample, the backscattered light containing Raman signals corresponding to each of the nominal wavelengths of excitation light, and separating the Raman signals in the backscattered light into separate Raman outputs, each Raman output containing a detectable Raman spectrum corresponding to one of the nominal wavelengths of excitation light. The Raman outputs may be combined into a single system output or each provided as a separate system output.

In certain embodiments, the probe includes optical connections for receiving the plurality of discrete wavelengths of excitation light from the one or more sources. The probe may include at least one laser source within the housing for providing at least one of the nominal wavelengths of excitation light. In certain embodiments, the probe includes a detector and/or a spectrograph within the housing for receiving the Raman outputs. In certain embodiments, one of the nominal wavelengths of excitation light is within the visible spectrum (it is visible light) and another of the nominal wavelengths of excitation light is within the near infrared spectrum (it is near-infrared light).

In certain embodiments, the probe includes at least one optical fiber for conducting the excitation light into the probe, and/or at least one optical fiber for conducting the Raman signals to a detector. The probe may include at least one fiber optic connector for connecting an optical fiber to the probe. In certain embodiments, the probe includes a dichroic filter that is less than about 10 percent transmissive of a 532 nm wavelength and at least about 90 percent transmissive of a 785 nm wavelength.

In certain embodiments, the probe includes a switch for toggling between the plurality of nominal wavelengths of excitation light. The plurality of nominal wavelengths of excitation light may be output from one or more lasers. In certain embodiments, the plurality of nominal wavelengths of excitation light consist essentially of (or consist of) two nominal wavelengths of excitation light.

In another aspect, the invention relates to a method for conducting Raman spectroscopy at a plurality of excitation wavelengths. The method includes the steps of combining a plurality of nominal wavelengths of excitation light into a single collimated beam, focusing the beam onto a sample, collecting backscattered light from the sample, the backscattered light containing Raman signals corresponding to each of the nominal wavelengths of excitation light, and separating the Raman signals in the backscattered light into separate Raman outputs, each Raman output containing a detectable Raman spectrum corresponding to one of the nominal wavelengths of excitation light. The description of elements of the probe in the embodiments described above can be applied to this aspect of the invention as well.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a schematic optical diagram of a dual excitation, fiber optically coupled Raman probe showing a configuration with two input fibers and two output fibers, according to an illustrative embodiment of the invention.

FIG. 2 is a schematic optical diagram of a dual excitation, fiber optically coupled Raman probe showing a configuration with two input fibers and one output fiber with combined emission spectra, according to an illustrative embodiment of the invention.

FIG. 3a is a schematic perspective view of a dual excitation, fiber optically coupled Raman probe head, according to an illustrative embodiment of the invention.

FIG. 3b is a schematic top view of optical elements within a dual excitation, fiber optically coupled Raman probe head, according to an illustrative embodiment of the invention.

FIG. 3c is a schematic perspective view of optical elements within a dual excitation, fiber optically coupled Raman probe head, according to an illustrative embodiment of the invention.

FIG. 3d is a schematic top view of laser sources within a dual excitation, Raman probe housing, according to an illustrative embodiment of the invention.

FIG. 3e is a schematic top view of laser sources and spectrographs within a dual excitation, Raman probe housing, according to an illustrative embodiment of the invention.

FIG. 4 is a graph showing a transmission spectrum of a dichroic edge filter, according to an illustrative embodiment of the invention.

FIG. 5 is a graph showing Raman spectra of cyclohexane obtained with a dual excitation, fiber optic Raman probe at 532 nm and 785 nm excitation wavelengths, according to an illustrative embodiment of the invention.

FIG. 6 is a graph showing Raman spectra of the mineral spodumene obtained with a dual excitation, fiber optic Raman probe at 532 nm and 785 nm excitation wavelengths, according to an illustrative embodiment of the invention.

FIG. 7 is a graph showing Raman spectra of the mineral feldspar obtained with a dual excitation, fiber optic Raman probe at 532 nm and 785 nm excitation wavelengths, according to an illustrative embodiment of the invention.

FIG. 8 is a graph showing a Raman spectrum of naphthalene containing a fluorescent impurity, as obtained with a dual excitation, fiber optic Raman probe with 532 nm and 785 nm lasers combined into a single output fiber, according to an illustrative embodiment of the invention.

FIG. 9 is a graph showing Raman spectra of hydrated ammonium nitrate obtained with a dual excitation Raman fiber optic probe at 532 nm and 785 nm excitation wavelengths, according to an illustrative embodiment of the invention.

### DETAILED DESCRIPTION

It is contemplated that devices, systems, methods, and processes of the claimed invention encompass variations and adaptations developed using information from the embodiments described herein. Adaptation and/or modification of the devices, systems, methods, and processes described herein may be performed by those of ordinary skill in the relevant art.

Throughout the description, where devices and systems are described as having, including, or comprising specific components, or where processes and methods are described as having, including, or comprising specific steps, it is contemplated that, additionally, there are devices and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

As used herein, “spectrum” is understood to mean a qualitative or quantitative measure of electromagnetic radiation intensity (i) over any range of frequency or wavelength, and/or (ii) at one or more discrete (or nominal) frequencies or wavelengths. The spectrum, as understood herein, can be the measurement itself or a signal that is indicative of the measurement.

As used herein, “signal” is understood to mean a variable parameter, such as a current or electromagnetic wave, by which information is conveyed.

As used herein, “a plurality of discrete nominal wavelengths of excitation light from one or more sources” is understood to mean excitation light having two or more different nominal wavelengths, where the excitation light is provided by one or more light sources (e.g., lasers). In certain embodiments, each of the nominal wavelengths of excitation light is provided by a separate light source (e.g., laser). In certain embodiments, one light source may provide excitation light at two or more different nominal wavelengths. The excitation light at a given nominal wavelength is not necessarily limited to that particular wavelength, but may have an associated bandwidth, e.g., which may vary according to the source of the light. In certain examples, the excitation light at a given nominal wavelength has a narrow bandwidth about the nominal wavelength.

In an embodiment, a dual excitation wavelength fiber optic Raman probe is provided that includes a housing having a proximal end and a distal end. The proximal end includes two input optical fibers, one for each of two laser sources, and two output optical fibers, one for each of two Raman spectra generated by the laser sources. Each input optical fiber receives light from a laser source and transmits the light into the housing. The housing contains optical elements for combining the laser light into a single, collimated beam, which is delivered to the sample from a beam output aperture at the distal end. The backscattered light containing the Raman spectra generated by the two laser sources is collected by the same aperture. Internal optics within the housing separate the Raman spectra and deliver them to the two output optical fibers. The output optical fibers conduct the Raman spectra to one or more spectrographs or detectors.

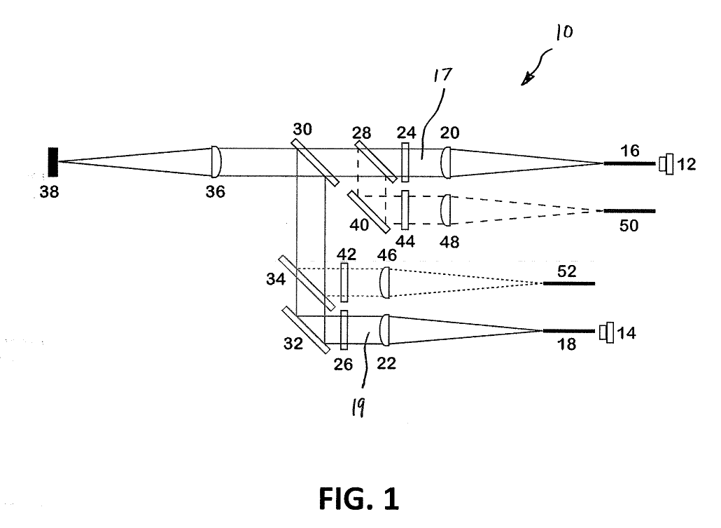

In the embodiment depicted in FIG. 1, a dual excitation wavelength fiber optic Raman probe 10 includes optical elements for directing laser light onto a sample and transmitting Raman spectra to a spectrograph or detector. The Raman probe 10 includes a near IR laser source 12 for generating near IR light at a wavelength of 785 nm, and a visible laser source 14 for generating visible light at a wavelength of 532 nm. Light from the near IR laser source 12 is conducted to the Raman probe 10 by input optical fiber 16 and travels within the Raman probe 10 along a near IR leg 17. Light from the visible laser source 14 is conducted to the Raman probe 10 by input optical fiber 18 and travels within the Raman probe 10 along a visible leg 19.

Upon entering the Raman probe 10 through the input optical fibers 16, 18, the light is collimated by lenses 20, 22 and directed through bandpass filters 24, 26. The bandpass filters 24, 26 are tuned to each laser wavelength and remove silica Raman bands and other spurious frequencies. In the near IR leg 17, a dichroic filter 28, tuned to pass the near IR frequency and reflect other wavelengths, is oriented at a 45° angle with respect to the optical path. A dichroic edge filter 30, that reflects the visible light and transmits the near IR light, is placed at 45° in the optical path following the dichroic filter 28. In the visible leg 19, a mirror 32 is placed at 45° in the optical path following the bandpass filter 26. The mirror 32 reflects the visible light at a 90° angle towards a dichroic filter 34, which is placed at 45° in the optical path and tuned to pass the visible laser light and reflect other wavelengths. After passing through the dichroic filter 34, the visible light is reflected at a 90° angle by a front reflective surface of the dichroic edge filter 30. The near IR beam and the visible beam depart the dichroic edge filter on the same optical axis as combined beams. The beams are focused by lens 36 onto identical spatial regions of the sample 38.

The scattered light from the sample, which contains the laser excitation sources and the Raman emission spectra from each source, is collected in backscatter and collimated by the same lens 36. The Raman emission spectra includes a visible spectrum, which is the spectrum excited by the visible beam, and a near IR spectrum, which is the spectrum excited by the near IR beam.

Optical elements within the fiber optic Raman probe 10 separate the visible spectrum and the near IR spectrum from the backscattered light and deliver them to a spectrograph or detector. The dichroic edge filter 30 selectively reflects at 90° the backscattered light containing the 532 nm laser wavelength and the visible spectrum. The visible spectrum extends from 532 nm out to a frequency shift of approximately 4000 cm⁻¹ to the low energy side of the source wavelength, or, in wavelength units, to about 676 nm. At the same time, the dichroic edge filter 30 passes the 785 nm laser wavelength along with its approximately 4000 cm⁻¹ near IR spectrum extending to about 1144 nm. Each dichroic bandpass filter 28, 34, placed at 45° in the optical paths of the 532 nm and 785 nm scattered light, allows the laser excitation light to pass while reflecting their respective Raman scattering spectra (i.e., the visible spectrum and the near IR spectrum) at longer wavelengths. The beam of the near IR spectrum is reflected off a 45° mirror element 40, so that both the visible spectrum and near IR spectrum beams are parallel and directed out to the proximal end of the fiber optic Raman probe 10. To further remove any remaining laser excitation light, the optical paths include an edge filter 42 to remove 532 nm and an edge filter 44 to remove 785 nm. The visible spectrum and near IR spectrum, with the laser excitation frequencies attenuated or removed, are focused by lenses 46, 48 into the output optical fibers 50, 52, which are directed to a spectrograph for readout. The spectrograph may record the spectra sequentially or, preferably, simultaneously. In an imaging spectrograph, for example, the spectra may be imaged on separate regions of a two dimensional charge coupled detector.

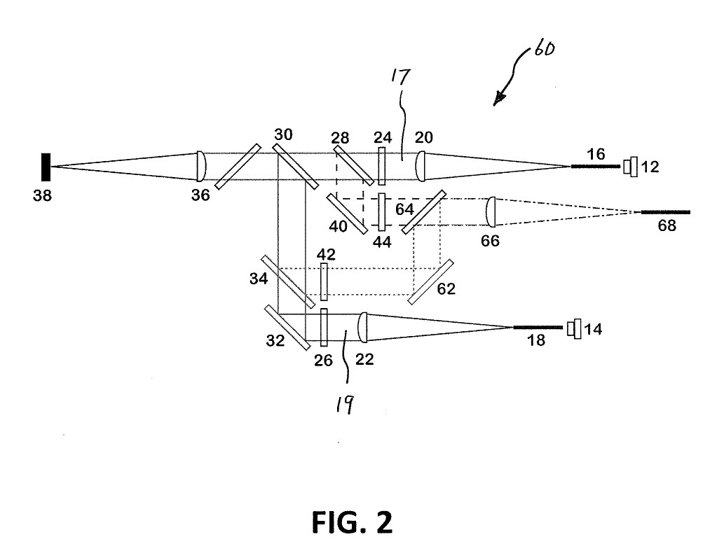

FIG. 2 depicts a single output Raman probe 60 in which the emission spectra are combined into a single channel and directed into a single output optical fiber. Like fiber optic Raman probe 10, single output Raman probe 60 is a dual excitation, fiber optically coupled Raman probe. In the depicted embodiment, after the visible spectrum beam and the near IR spectrum beam exit the edge filters 42, 44, they are combined using a 45° mirror element 62 and a 45° dichroic edge filter 64. Dichroic edge filter 64 is tuned to pass the near IR spectrum and reflect the visible spectrum. As a result, the visible spectrum beam is reflected by the 45° dichroic edge filter 64 onto the same optical axis defined by the near IR spectrum beam. The combined beams are focused by lens 66 into the single return fiber 68, which is directed to a single spectrograph or detector with sufficient spectral range to record both spectra.

Both fiber optic Raman probe 10 and single output Raman probe 60 may be constructed with the excitation lasers internal to the probe, and therefore the input optical fibers carrying the laser sources may be eliminated. In this modification, only one or two output optical fibers would emanate from the probe head for remote connection to the light detection instrumentation. Furthermore, the lasers may be combined with an electronic or optical switch to toggle among them. This may be useful, for example, when the 532 nm source gives rise to a particularly broad fluorescence. If this interfering fluorescence extends to beyond 785 nm, it may leak over into the 785 nm Raman detection channel, causing interference. In this case, it may be advantageous to have the capability to turn off the 532 nm laser during the 785 nm excited Raman measurement.

The embodiments depicted in FIGS. 1 and 2 are but two ways in which a fiber optically coupled, dual or multi-wavelength Raman probe may be constructed. Many different arrangements of the internal optical elements are possible that will give the same result. Examples of modifications include use of alternative filter sets, different types of lenses such as GRIN lenses, use of holographic filters in place of bandpass filters, placement of optical elements at different angles, inclusion of mirrors to change the direction of the optical beams, and inclusion of internal switching elements to toggle among the different laser sources.

Additional optical channels or legs may be added to the probe to provide more than two excitation wavelengths focused onto the sample and more than two Raman spectra collected. For example a third channel is achieved by replacing mirror element 32 with a dichroic filter, which is designed to pass the added laser wavelength. The added wavelength may be shorter than the wavelength from laser source 14. Light from the added laser source is directed along a leg that includes optical elements arranged like those used for laser source 14 (i.e., the visible leg 19).

In constructing multi-wavelength probes, it is preferred that the Raman spectra collected by each leg do not overlap in wavelength. Overlap may cause Raman bands, arising from the different excitation sources, to be confused if they are being recorded simultaneously. Such confusion may be avoided by toggling among the laser sources and recording each spectrum individually.

While laser sources 12, 14, described above, produce wavelengths of 532 nm and 785 nm, other or additional excitation wavelengths may be utilized. For example, an excitation wavelength may be any value between about 200 nm and about 2000 nm (these wavelengths may be categorized as ultraviolet [200-400 nm], visible [400-700 nm] and near infrared [700-2000 nm]). In addition, rather than using lasers as the light source, the light may come from other sources, such as LEDs, gas discharge lamps and broadband light sources passed through a filter to produce a narrow excitation frequency range. In one embodiment, the laser sources include a miniature 532 nm frequency doubled neodymium YAG (100 mW) and a 783.5 nm diode source (200 mW).

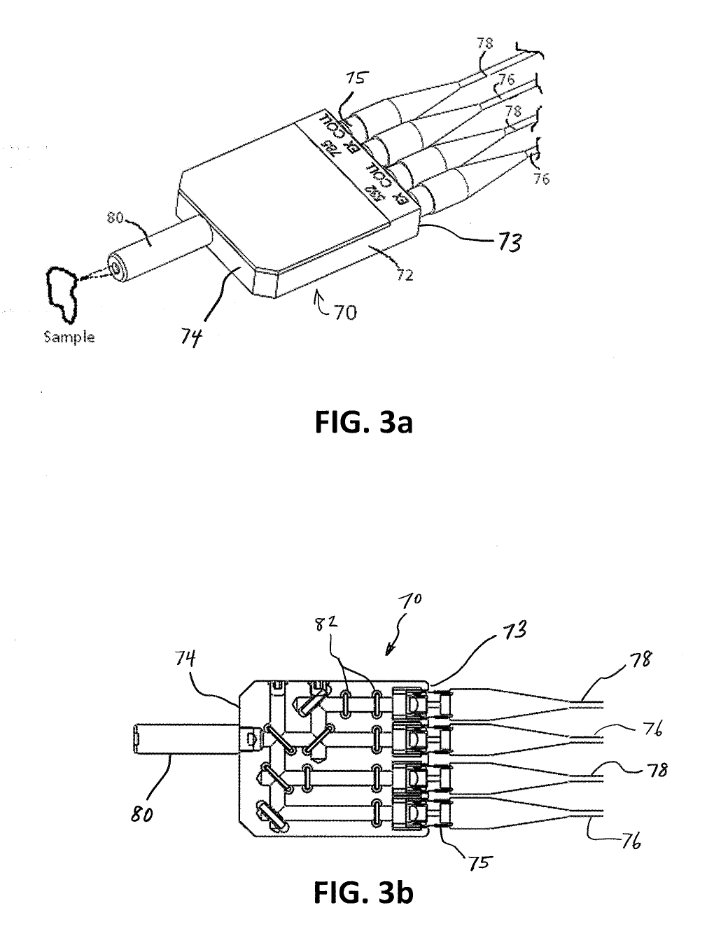

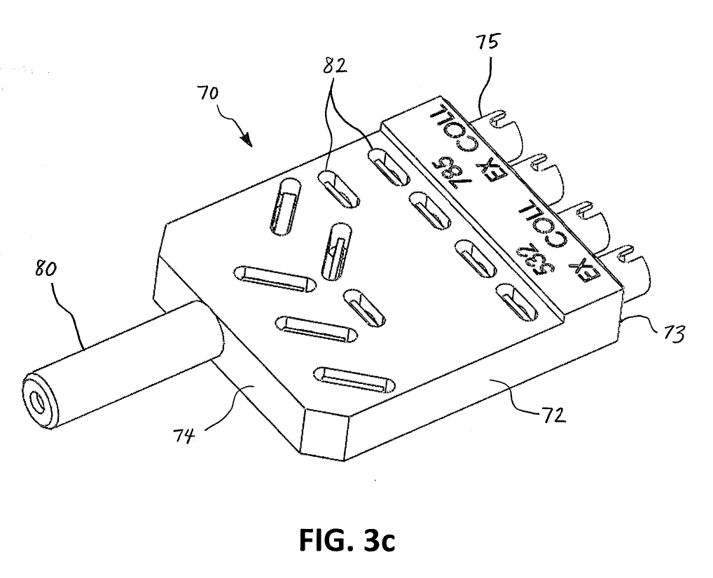

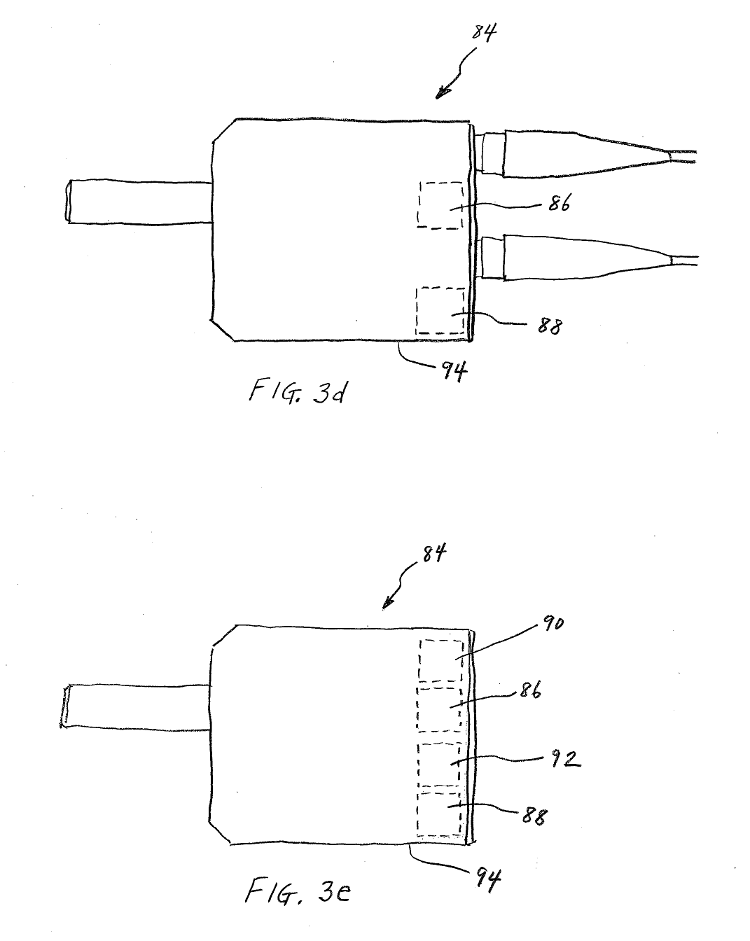

The optical elements, such as those depicted in FIGS. 1 and 2, are typically contained within a probe housing that can be conveniently manipulated or positioned to address a sample under test. For example, FIGS. 3a, 3b, and 3c depict a dual excitation, fiber optically coupled Raman probe head 70 that includes a sealed probe housing 72 having a proximal end 73 and a distal end 74. Referring to FIG. 3b, the optical elements within the probe head 70 may be the same as those in fiber optic Raman probe 10. The proximal end 73 includes four fiber optic connectors 75 from which input excitation fibers 76 and output collection fibers 78, for the two excitation wavelengths (e.g., 532 nm and 785 nm), can be quick-connected. A tube 80, containing the focusing optics for sample excitation, is on the distal end 74. As depicted in FIG. 3c, the probe housing 72 may include slots or guides 82 for accurate and reproducible placement of the optical components. Similar probe bodies can be configured for alternative optical configurations or ergonomics. For example, input and output ports may be located in different positions, the probe housing may be cylindrical, and/or the probe housing may include a pistol grip. Probe bodies may be fabricated from any solid material, including metals, polymers, and/or composites.

As depicted in FIGS. 3d and 3e, an integrated Raman probe 84 may include one or more laser sources 86, 88 and/or detectors or spectrographs 90, 92 integrated within a housing 94. Including the laser sources 86, 88 and/or spectrographs 90, 92 within the housing 94 may eliminate the need for fiber optic coupling to an external laser source and/or an external detector or spectrograph.

### EXAMPLES

### Example 1

### Dual Excitation Raman Probe Construction and Operation

A dual excitation fiber optic Raman probe was constructed using the optical configuration shown in FIG. 1, with two input and two output optical fibers. The optics were housed in a probe head similar to the design depicted in FIG. 3a. The dimensions of the probe housing were approximately 2″ wide by 2″ long by 0.5″ thick, and the tube containing the focusing/collection optics was approximately 1.5″ long by 0.5″ in diameter. The input excitation lasers were miniature 532 nm frequency doubled neodymium YAG (100 mW) and a 783.5 nm diode source (200 mW).

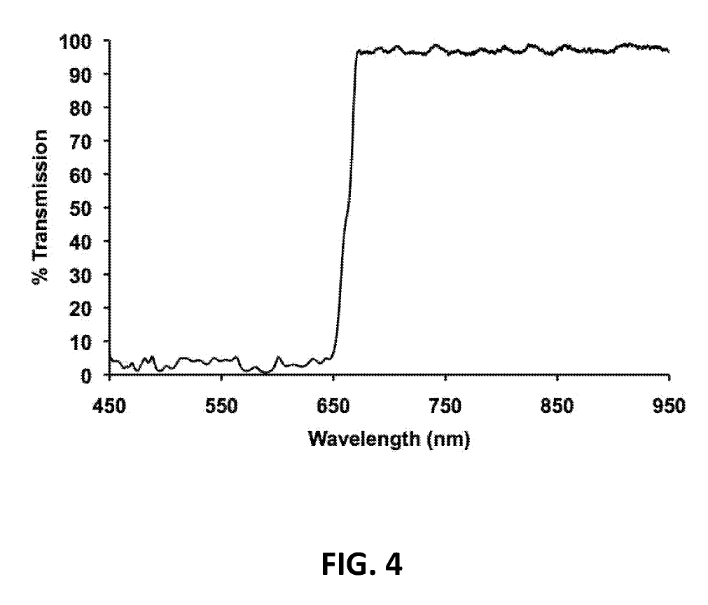

FIG. 4 depicts the transmission spectrum of the dichroic edge filter 30. As depicted, the dichroic edge filter 30 is more than 90% transmissive of the 785 nm excitation wavelength and the Raman spectrum generated to longer wavelengths. The dichroic edge filter 30 is reflective of the 532 nm excitation source and the Raman spectrum generated out to about 660 nm, or a spectrum coverage of approximately 3700 cm⁻¹.

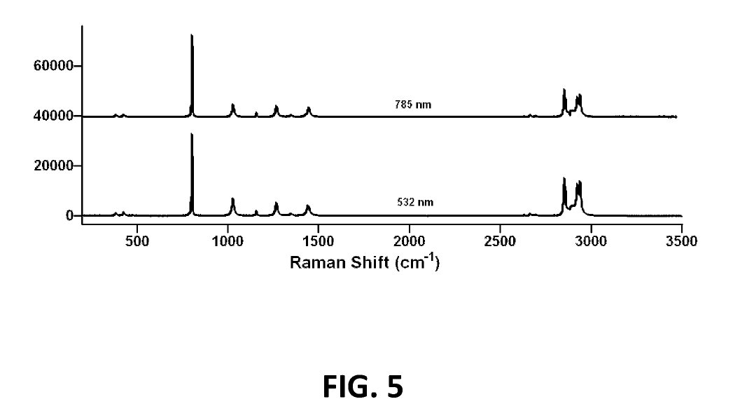

FIG. 5 shows the Raman spectrum of cyclohexane obtained with the probe at the two excitation wavelengths. The probe throughput in both legs is high resulting in spectra with very low noise, and the spectral coverage extends from about 100 cm⁻¹ to beyond 3500 cm⁻¹. The spectra are identical as there are no interfering signals at either excitation wavelength for this sample.

### Example 2

### Application of the Dual Wavelength Probe to a Sample with Visible Fluorescence

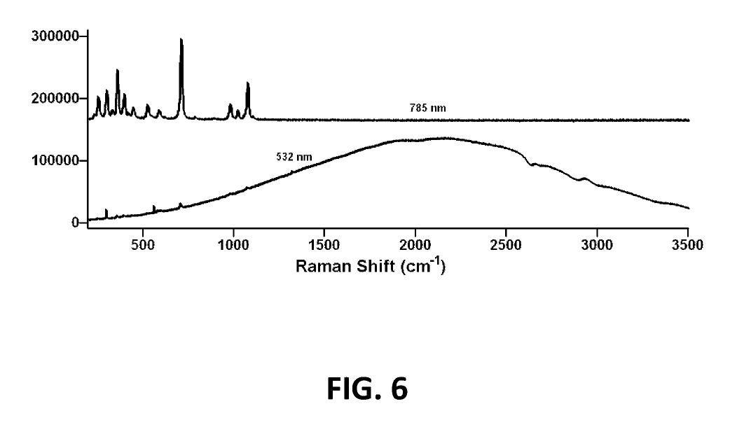

To illustrate the advantageous function of the dual wavelength probe of Example 1, FIG. 6 shows the full range Raman spectra of the mineral spodumene (lithium aluminum silicate) obtained with the Raman probe at 532 nm and 783.5 nm excitations. It can be seen from the Raman spectra of spodumene that a 532 nm excitation is not suitable for this sample since it contains impurities that emit a strong fluorescence background that obscures the Raman bands. The near IR Raman excitation (783.5 nm), however, shows no fluorescence background and the Raman bands are readily observed. The results shown in FIG. 6 illustrate a main advantage of the dual excitation Raman fiber optic probe, where the probe allows the acquisition of Raman spectra from a sample which fluoresces in the visible region by employing a near IR excitation source.

### Example 3

### Application of the Dual Wavelength Probe to a Sample with Near IR Fluorescence

Some samples exhibit interfering emissions when excited at longer wavelengths that are absent when shorter wavelength excitation is employed. For example, an emission process that may interfere with Raman identification is F-center luminescence, which is common in minerals due to anion vacancies. F-center luminescence bands also exhibit narrow bandwidth that may be mistaken for Raman emission.

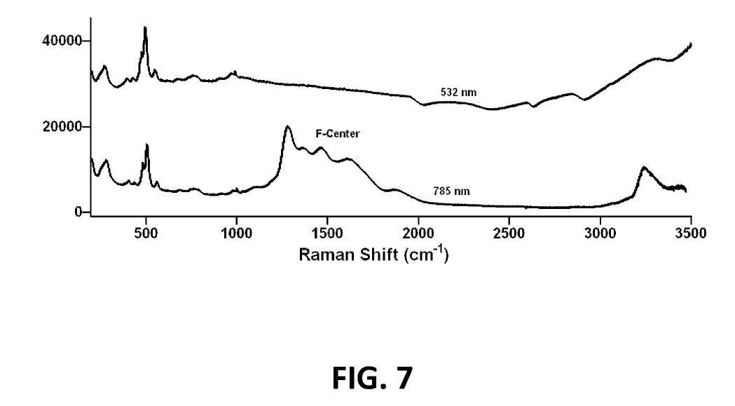

FIG. 7 shows the Raman spectra of a feldspar mineral sample that was obtained with the dual Raman probe of Example 1 at 532 nm and at 783.5 nm. The Raman bands are observed at both wavelengths. However, with 783.5 nm excitation, F-center luminescence bands are present in the 1100 cm⁻¹ to 2000 cm⁻¹ range. Since they are absent with 532 nm excitation, it can be concluded that they are indeed luminescence bands.

### Example 4

### Simultaneous Measurement of Raman Spectra at Two Excitation Wavelengths with a Single Spectrograph

One important feature of the dual excitation Raman probe that could be quite useful in Raman analysis is that it allows for the simultaneous Raman acquisition of the visible and near infrared Raman spectral ranges, as well as any luminescence background spectrum. To illustrate this point, the Raman spectra of naphthalene with a fluorescent impurity were recorded simultaneously at 532 nm and 785 nm excitation with the Raman probe of Example 1.

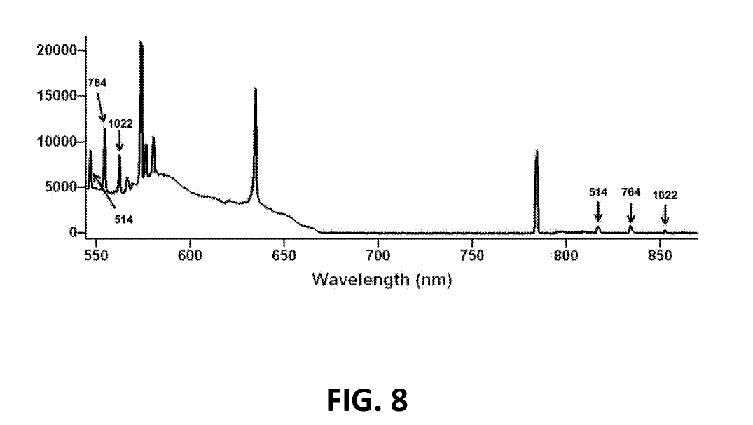

FIG. 8 shows the spectrum that was recorded and includes an x-axis of wavelength instead of Raman shift (i.e., Δcm⁻¹). With 532 nm excitation, the full Raman spectrum (along with some background fluorescence from the impurity) can be seen as indicated by the presence of the strong CH Raman band at about 635 nm (3050 cm⁻¹ shift from 532 nm). The spectrograph that was used does not have wide enough coverage to show the full range Raman spectrum at 785 nm; nevertheless, the low frequency Raman bands (i.e., less than 1100 cm⁻¹) could still be observed. The Raman bands that can be seen with 785 nm excitation are the 514 cm⁻¹, 764 cm⁻¹, and 1022 cm⁻¹ vibrations. The Raman intensities at 785 nm are also much weaker, mainly because the grating efficiency starts to decrease considerably at these wavelengths and the CCD quantum efficiency is falling rapidly.

### Example 5

### Application to Samples with Hydroxyl (—OH) Bands

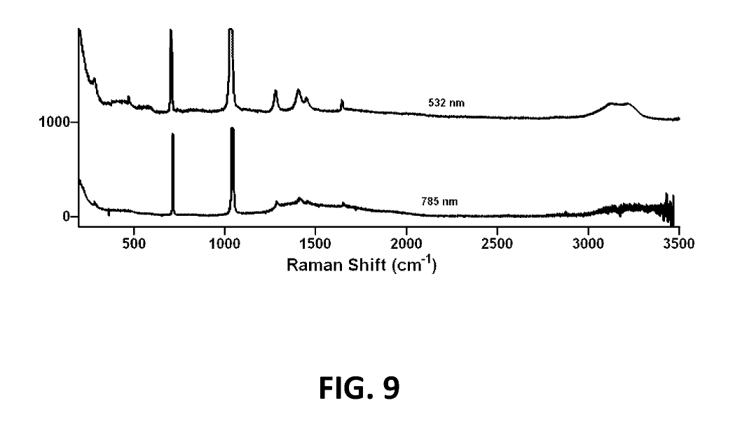

It is particularly advantageous in Raman analysis of materials containing hydroxide or water to have the shorter wavelength excitation always available for the possibility of accessing the important —OH frequency range. FIG. 9 illustrates this point by comparing the Raman spectra of hydrated ammonium nitrate obtained at 532 nm and 785 nm laser excitations, using the dual excitation Raman probe of Example 1. The water peak centered at 3200 cm⁻¹ is clearly present in the 532 nm Raman spectrum, but not in the 785 nm Raman spectrum. Also, the signal to noise intensity at Raman shifts greater than 3000 cm⁻¹ is high with the 785 nm excitation source, which is due to the low quantum efficiency of the CCD detector in this region.

### Equivalents

While the invention has been particularly shown and described with reference to specific embodiments, it should be understood by those skilled in the art that various changes in form and detail may be made therein without departing from the spirit and scope of the invention as defined by the appended claims. The features and functions of the various embodiments may be arranged in various combinations and permutations, and all are considered to be within the scope of the disclosed invention. The relevant teachings of all the references, patents and patent applications cited herein are incorporated herein by reference in their entirety.

What is claimed is:

1. A sampling probe for conducting Raman spectroscopy at a plurality of excitation wavelengths, the probe comprising, in a single housing, optical components for:
combining a plurality of discrete nominal wavelengths of excitation light from one or more sources into a single collimated beam;
focusing the beam onto a sample;
collecting backscattered light from the sample, the backscattered light containing Raman signals corresponding to each of the nominal wavelengths of excitation light; and
separating the Raman signals in the backscattered light into separate Raman outputs, each Raman output containing a detectable Raman spectrum corresponding to one of the nominal wavelengths of excitation light.

2. The probe of claim 1 wherein the Raman outputs are combined into a single system output.

3. The probe of claim 1 wherein the Raman outputs are each provided to a separate system output.

4. The probe of claim 1 further comprising optical connections for receiving the plurality of nominal wavelengths of excitation light from the one or more sources.

5. The probe of claim 1 further comprising at least one laser source within the housing for providing at least one of the nominal wavelengths of excitation light.

6. The probe of claim 1 further comprising at least one of a detector or spectrograph within the housing for receiving the Raman outputs.

7. The probe of claim 1, wherein a first nominal wavelength of excitation light is visible light and wherein a second nominal wavelength of excitation light is near-infrared light.

8. The probe of claim 1 further comprising at least one optical fiber for conducting the excitation light into the probe.

9. The probe of claim 1 further comprising at least one optical fiber for conducting the Raman signals to a detector.

10. The probe of claim 1 further comprising at least one fiber optic connector for connecting an optical fiber to the probe.

11. The probe of claim 1 further comprising a dichroic filter that is less than about 10 percent transmissive of a 532 nm wavelength and at least about 90 percent transmissive of a 785 nm wavelength.

12. The probe of claim 1 further comprising a switch for toggling between the plurality of nominal wavelengths of excitation light.

13. The probe of claim 1, wherein the one or more sources of excitation light are one or more lasers.

14. The probe of claim 1, wherein the plurality of nominal wavelengths of excitation light consist essentially of two discrete wavelengths of excitation light.

15. A method for conducting Raman spectroscopy at a plurality of excitation wavelengths, the method comprising:
combining a plurality of nominal wavelengths of excitation light into a single collimated beam;
focusing the beam onto a sample;
collecting backscattered light from the sample, the backscattered light containing Raman signals corresponding to each of the nominal wavelengths of excitation light; and
separating the Raman signals in the backscattered light into separate Raman outputs, each Raman output containing a detectable Raman spectrum corresponding to one of the nominal wavelengths of excitation light.
